(19) United States
(12) Patent Application Publication
(10) Pub. No.: US 2002/0140846 A1
(43) Pub. Date: Oct. 3, 2002

(54) System for supplying backup electricity

(76) Inventor: Ping-Yim Cheung, Tai Lam (HK)

Correspondence Address: Y. ROCKY TSAO, Fish & Richardson P. C., 225 Franklin Street, Boston, MA, 02110-2804, US

(21) Appl. No.: 09/821,211

(22) Filed: Mar. 29, 2001

(51) Int. Cl. H04N 5/225

(52) U.S. Cl. 348/372

(57) ABSTRACT

A system for supplying backup electricity from a secondary battery in which the power for the electric device is supplied by a primary battery while the secondary battery remains disconnected from the electric device until triggered by an action of the user.

### FIELD OF INVENTION

The present invention relates generally to battery connections and switches and more particularly to switching mechanisms between backup and main batteries.

### BACKGROUND OF INVENTION

Images captured on digital cameras are stored in either flash RAM memory or volatile memory such as static dynamic (SD) RAM. Flash RAM memory does not require a minimum supply of electricity for normal data storage while volatile memory would be lost if the battery runs out or is detached from the system. Thus flash RAM memory is often the preferred medium of storage for digital cameras. Flash RAM memory, however, are more expensive than volatile memory and there is a continued demand for the use of volatile memory in digital cameras. There is therefore the need to improve the reliability of digital cameras that use volatile memory.

### SUMMARY OF INVENTION

Accordingly, the present invention provides a system for supplying backup electricity from a secondary battery in which the power for the electric device is supplied by a primary battery while the secondary battery remains disconnected from the electric device until triggered by an action of the user.

According to another aspect of the present invention, the action of the user may involve a battery changing step whereby the user opens the primary battery compartment in the process of removing the spent primary battery. A coupling mechanism is provided for switching on the electric supply from the secondary battery when the compartment is opened.

In the preferred embodiment, a primary electric connection is provided between the electrical device and the primary battery such that the proper loading of the primary battery completes the electric circuit between the primary battery and the electric device. A secondary electric circuit between the electric device and the secondary battery is also provided and contains a circuit switch for opening and closing the secondary electric circuit. The electric device is provided with a casing that has an opening and closing mechanism. This mechanism is coupled to the switch of the secondary electric circuit such that the opening of the casing triggers the closing of the switch and the secondary electric circuit, while the closing of the casing results in the opening of the switch and the secondary electric circuit.

The advantage of this system is that the energy stored in the secondary battery is only used when the coupling mechanism is triggered, extending the life of the secondary battery tremendously. As a result, total power failure may be avoided, rendering the entire device more reliable.

### BRIEF DESCRIPTION OF DRAWINGS

FIGS. 1A and B are the front and back perspective views of the camera according to one embodiment of the present invention, with the lid of the primary battery compartment shown in the detached position to show the location of the compartment in the casing.

FIG. 2 is a partial circuit diagram of one embodiment of the present invention.

FIGS. 3A and B are the partial back plan view of the same embodiment of the present invention with the primary battery compartment lid in an opened (FIG. 3A) or closed (FIG. 3B) position.

### DETAILED DESCRIPTION

In the description in the accompanying claims, the terms “comprising” “including” and “containing” are meant to be open-ended in their meaning and should be interpreted to have the meaning “but not limited to . . . ”. A digital camera is used as an illustrative example of the principles of the present invention.

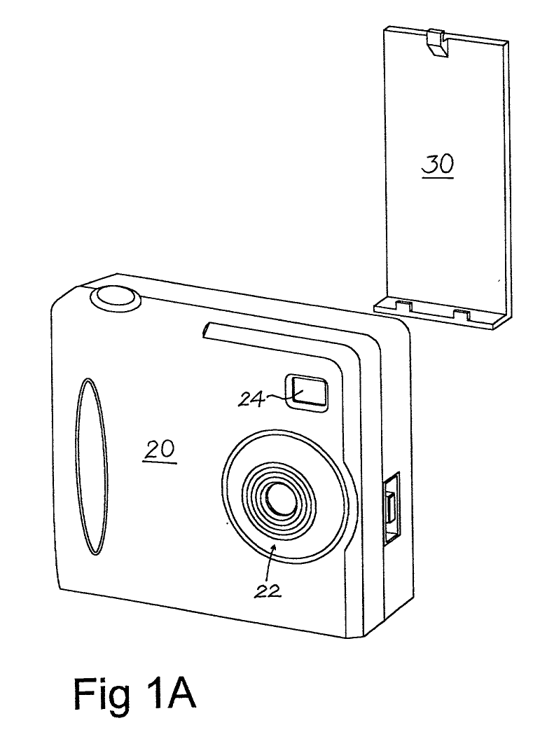

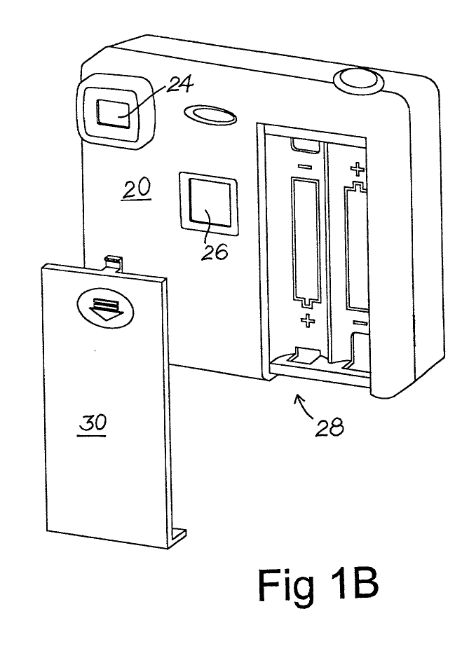

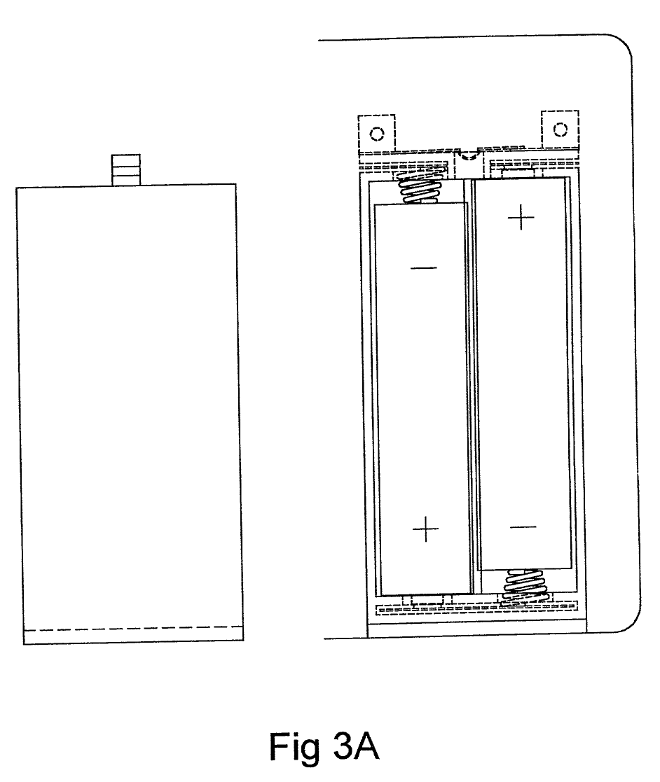

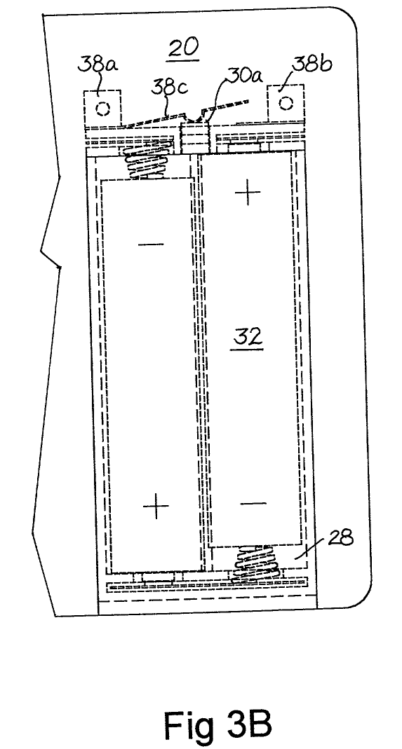

Referring to FIGS. 1A and B, the illustrative camera according to the present invention has a casing 20, a lens module 22, a view finder 24 and a LCD display module 26. The rear section of the casing is formed into a compartment 28 for retaining the primary battery. The compartment is provided with all the necessary electrical connections to electrically connect properly installed batteries to the appropriate electronic modules of the camera. The details of the circuit are not shown for ease of understanding but should be understood to include well known elements, for example, printed circuit boards, electronic and mechanical components. A window 28a (shown in FIGS. 3A and 3B) is provided in compartment 28. A lid 30 is provided for closing the primary battery compartment, and contains a protrusion 30a.

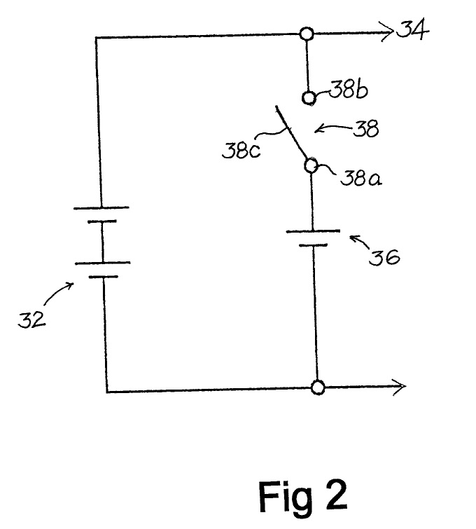

FIG. 2 shows a partial circuit diagram to illustrate how the present invention may be practised. The primary battery 32 is connected to the electronic components 34 of the camera (details not shown) and supply electricity thereto. For ease of description, this is referred to as a primary circuit. The secondary battery 36 is also connected to device 34, but with the switch 38 provided therein. The switch comprises a first contactor plate 38a, a second contactor plate 38b and a connector plate 38c. This section of the circuit is referred to as the secondary circuit. When connector plate 38c is in the opened position, the secondary circuit is opened and the secondary battery is isolated from the electronics modules. When the connector plate 38c is in the closed position, the switch is closed and the secondary circuit is closed such that electricity from the secondary battery can power the electronic components of the camera.

Referring now to FIGS. 3A and B, the contactor plates 38a and 38b are attached to two opposing sides of window 28a provided inside compartment 28. Connector plate 38c is formed as an integral extension from the first contactor plate 38a and extends across window 28a.

During use, the lid 30 of battery compartment 28 is properly inserted. Protrusion 30a mate within window 28a and acts as a triggering element such that connector plate 38c is displaced into an inclined position. As a result, an open circuit is created in the secondary circuit, and electricity is supplied only by the primary battery. When the lid is removed (e.g. during primary battery change), protrusion 30a is removed from window 28a, allowing connector 38c to touch contactor plate 38b.

Using the system described, backup electricity is only consumed when user is manipulating the compartment lid, substantially increasing the life of the backup electricity.

While the present invention has been described particularly with references to the aforementioned figures with emphasis on a triggering element and a removable lid of a digital camera, it should be understood that the figures and examples are for illustration only and should not be taken as limitation on the invention. It is contemplated that many changes and modifications may be made by one of ordinary skilled in the art without departing from the spirit and the scope of the invention described. For example, another coupling mechanism may be provided that operate in conjunction with a hinged or sliding lid. The contactor is described as a flexible metal plate, but other movable conductive components may also be used to practise the present invention.

1) a system for supplying backup electricity from a secondary battery to an electrical device, said electrical device provided with a casing, said casing adapted for receiving at least one primary battery, said system comprising:
a primary electrical circuit between the electrical device and said primary battery such that the proper loading of said primary battery completes the electric connection between said primary battery and said electric device;
a secondary electric circuit between said electrical device and said secondary battery, said secondary electric circuit further containing a switch for opening and closing said secondary electric circuit; and
a coupling mechanism between said casing and said switch such that the opening of said casing triggers the closing of said switch and said secondary electric circuit and the closing of said casing results in the opening of said switch and said secondary electric circuit.

2) A system according to claim 1 wherein said casing is provided with a primary battery compartment closable with a lid; said coupling mechanism comprising a triggering element provided on said lid; and said opening of said casing involves opening said lid.

3) A system according to claim 2 wherein said switch further comprises:
a first contactor and a second contactor, said first contactor electrically connected to one pole of said secondary battery, said second contactor electrically connected to the opposite pole of said secondary battery; and
a connector adapted for electrically coupling said first and second contactor, said connector movable between an open circuit position and a close circuit position, said triggering element engaging said connector in said open circuit position when said lid is in the closed position, said connector further automatically moving into a close circuit position when said casing lid is opened.

4) A system according to claim 3 wherein said electrical device comprises the electronic of a digital camera.

5) A method for supplying backup electricity from a secondary battery to an electrical device, said electrical device provided with a casing, said casing adapted for receiving at least one primary battery, said method comprising:
providing a primary electrical circuit between the electrical device and said primary battery such that the proper loading of said primary battery completes the electric connection between said primary battery and said electric device;
providing a secondary electric circuit between said electrical device and said secondary battery, said secondary electric circuit further containing a switch for opening and closing said secondary electric circuit; and
coupling said casing and said switch such that the opening of said casing triggers the closing of said switch and said secondary electric circuit and the closing of said casing results in the opening of said switch and said secondary electric circuit.
